(19) United States
(12) Patent Application Publication
(10) Pub. No.: US 2005/0255287 A1
(43) Pub. Date: Nov. 17, 2005

(54) Wiper and method of manufacturing the wiper

(76) Inventors: Yuichi Komuro, Hyogo (JP); Shuji Yuge, Miyazaki (JP)

Correspondence Address: Finnegan Henderson Farabow;Garrett & Dunner, 1300 I Street NW, Washington, DC, 20005-3315, US

(21) Appl. No.: 10/520,666

(22) PCT Filed: Feb. 25, 2003
(86) PCT No.: PCT/JP03/02063

§ 371 Date: Jan. 10, 2005

(30) Foreign Application Priority Data
Jul. 11, 2002 (JP) 2002-203131

(51) Int. Cl. B32B 5/12; B23P 17/00

(52) U.S. Cl. 428/113; 29/419.1

(57) ABSTRACT

A sheet-like wiper of a nonwoven fabric formed by entangling fibers with each other by a high-pressure water jet stream, wherein an amount of micro-matter of 100 μm long or more falling-off therefrom is 20,000 pieces/m² or less, an amount of material dissolved therefrom into acetone is 340 mg/kg or less, and the water absorption is 8 ml/g or more.

### TECHNICAL FIELD

The present invention relates to an industrial wiper suitably used in a clean room, in the electronic product industry or the pharmaceutical product industry, requiring a high cleanness, and to a method for manufacturing the wiper.

### BACKGROUND ART

A wiper using nonwoven material has widely been used in the domestic, medical and industrial fields as a disposable wiper because of its low price, while the functions thereof required for the respective fields are different from each other. For example, in the domestic use, a wiper represented by a dishcloth or a duster is required to have breaking strength and bulkiness. In a domestic floor-sweeping wiper, the dust-absorption performance is important. In medical use, it is strongly required that no heavy metals or fluorescent compounds, harmful to a human body, are contained therein because the wiper is used in place of cotton gauze.

On the other hand, in industrial use, disposable wipers of nonwoven fabric have been used in various fields. Of them, in clean rooms of the electronic product industry or the pharmaceutical product industry, the disposable wipers of nonwoven fabric are used for manually wiping a ceiling, a wall, a floor, a device or a jig for the purpose of keeping the room very clean. Disposable wipers of nonwoven material are also used for wiping out dirt or unnecessary liquid adhered to a part being produced. While these wipers are usually provided in a dry state, they may be provided in a state preliminarily moistened with liquid for the purpose of facilitating the convenience of the user. Particularly, as a special-use wiper in a biological industry, the wiper may be subjected to sterilization treatment such as EOG sterilization, hot steam sterilization, γ-ray sterilization or electronic beam sterilization to increase the added value.

As the nonwoven fabric wiper used in a clean room in an industrial field must has a high degree of cleanness, it is preferably of a single-sheet shape rather than a folded shape. That is, the disposable wiper is disposed of when the surface thereof is contaminated. If the wiper is of the folded shape, it is disposed while an inner surface thereof is still unused, which is uneconomical. At present, various sheet-like nonwoven fabric wipers have been marketed as commercial products, including in dry and wet states, and they are used for operations not only in a clean room but also in many other field wherein there is a need for cleaning objects.

Although the sheet-like nonwoven fabric wiper has been used in a clean room in an industrial field as described above, more excellent wipers satisfying all of extremely high and various performances are still desired.

That is, a first important performance of the industrial-use wiper is that it is free from the generation and falling-off of micro-dust. While the dust has various sizes, micro-dust having a size of 100 μm long or more, is fibrous matter (fiber dust) falling off from the wiper material. The adhesion of the fibrous matter (fiber dust) is a serious problem not only when the wiper is used in the clean room but also when a surface to be coated is cleaned prior to a coating operation.

Table 1 shows the performance of the conventional sheet-like nonwoven fabric wipers most popularly used in the market wherein A, B, C, D and E are composed of wood pulp and polyester fiber, F and G are composed of wood pulp and polyester fiber treated with resinous binder, and H is composed of rayon and polyester fiber. In all of the above-mentioned sheet-like nonwoven fabric wipers, a fibrous sheet web is subjected to a high-pressure water jet stream (a so-called water jet needling) to entangle fibers therein with each other to form a nonwoven fabric. I is a melt-blown nonwoven fabric wiper.

Chemical bond nonwoven fabrics or thermal bond nonwoven fabrics are unsuitable for the sheet-like nonwoven fabric wiper used in the clean room in view of impurities and the hand.

As is apparent from the measured values shown in Table 1 obtained by the present inventors, an amount of micro-matter (dust) of 100 μm long or more falling off from the marketed sheet-like nonwoven fabric wiper is surprisingly as much as in a range from 22,500 pieces/m² which is minimum (H) to 100,000 pieces/m² or more (A to E used for general purposes). Accordingly, none of the conventional wipers has been satisfactory in view of the amount of micro-matter falling-off therefrom. Since the generation of such a large amount of micro-matter causes various problems, it is necessary to reduce the same as much as possible.

A second important required performance of the industrial-use wiper is that an amount of material dissolved from the wiper into solvent is low. When the operator carries out the cleaning operation in the clean room by the nonwoven fabric wiper, the wiper is often wetted with organic solvent in the same way as the domestic duster is used while being wetted with water. This is because the persistent contamination of resin or oil within a chamber, which is impossible to be wiped off with water, can be cleaned, for example, by acetone having a high dissolving power. However, this is problematic in that a large amount of material such as spinning oil, hydrophilic treatment agent, binder or oligomer in the polyester fiber material (mainly composed of triethyleneglycol) is dissolved from the conventional nonwoven fabric wiper into the acetone.

If the wiper is coated with adhesive resin to restrict the falling-off of the above-mentioned fibrous micro-matter, the amount of material dissolved into acetone further increases. Accordingly, it is necessary to use alcohol (mainly isopropyl alcohol: IPA) as solvent for the cleaning operation, which is less problematic regarding dissolved material but weaker in dissolving power. Such a countermeasure reduces the cleaning effect, and therefore a nonwoven fabric wiper low in the amount of material dissolved into acetone has been required. As is apparent from Table 1, A, B, F, G and I are unsatisfactory.

A third important performance required by the market is that the wiper has large water absorption. Various aqueous solutions such as sulfuric acid or nitric acid are used in the clean room and often overflow or drip. As the solution must be wiped up by the nonwoven fabric wiper in such a case, the water absorption thereof is preferably large. As the synthetic fiber inherently has small water absorption, the wiper using the synthetic fiber is coated with hydrophilic agent (surfactant) or subjected to a hydrophilic treatment, which increases the amount of material dissolved from the wiper into acetone.

In the prior art, a cellulose component has been mixed in the nonwoven fabric material of the wiper to improve the water absorption. However, if pulp fiber is used as the cellulose component, the generation of fibrous micro-matter increases. As apparent from Table 1, the water absorption of the conventional sheet-like nonwoven fabric wipers is generally in a range from 4 to 6 ml/g, and at most 8 ml/g or less.

As described hereinbefore, there has been no sheet-like nonwoven fabric wiper free from all the problems of the amount of fibrous micro-matter falling-off therefrom, the amount of material dissolved therefrom into acetone and the water absorption. At present, the consumer has used the conventional wipers with a risk the above-mentioned problems. Accordingly, the sheet-like nonwoven fabric wipers at a reasonable price, capable of being largely consumed as disposable material are still required.

### DISCLOSURE OF THE INVENTION

An object of the present invention is to provide a sheet-like nonwoven fabric wiper having a totally excellent performance being low in falling-off of micro-matter (dust) therefrom or in material dissolved into acetone therefrom, and large in water absorption, and a method for manufacturing the same.

The present inventors have diligently studied to solve the above-mentioned problems and made the present invention.

The present invention is as follows:

1. A sheet-like wiper of a nonwoven fabric formed by entangling fibers with each other by a high-pressure water jet stream, wherein an amount of micro-matter of 100 μm long or more falling-off therefrom is 20,000 pieces/m² or less, an amount of material dissolved therefrom into acetone is 340 mg/kg or less, and the water absorption is 8 ml/g or more.

2. A wiper as defined by 1 mentioned above, wherein the amount of micro-matter of 100 μm long or more falling-off therefrom is 14,000 pieces/m² or less, the amount of material dissolved therefrom into acetone is 190 mg/kg or less, and the water absorption is 9 ml/g or more.

3. A wiper as defined by 1 or 2 mentioned above, wherein the nonwoven fabric contains cellulose filament fiber of 40% by weight or more, and the cellulose filament fiber is cupra-ammonium rayon.

4. A wiper as defined by 3 mentioned above, wherein the content of the cellulose filament fiber is 85% by weight or more.

5. A method for manufacturing a wiper, comprising a process for producing nonwoven fabric of cellulose filament fiber by a wet type cellulose spun-bonding method wherein cupra-ammonium cellulose solution is continuously coagulated, regenerated, rinsed, entangled, dried and taken up to form a nonwoven fabric, a process for combining the nonwoven fabric with other nonwoven fabric if necessary, a process for cutting the nonwoven fabric to be a flat sheet-like wiper, a process for wetting the wiper with liquid if necessary and/or a process for sterilizing the wiper if necessary, wherein the entanglement process is carried out by placing a buffer plate having an opening degree in a range from 10 to 47% on a non-entangled web and applying onto the buffer plate a water jet stream having a total impact energy value (F) in a range from 0.5×10⁹ to 3.0×10⁹ joule·newton/kg to entangle fibers in the web.

The present invention will be described in more detail below.

The wiper referred to in this text is a wiper obtained by cutting a nonwoven fabric which is a raw material into a sheet and supplied as a flat sheet-like product. A shape of the sheet may be any of square, rectangular, circular or polygonal or others.

Since the inventive wiper is used while being flatly gripped by a hand of the operator, the breaking strength and the flat shape-retaining property durable against the use are required.

The inventive wiper is composed of a nonwoven fabric in which fibers are entangled with each other by the action of the high-pressure water jet stream. As this nonwoven fabric has the breaking strength sufficient for maintaining the shape thereof even if it is gripped by the operator's hand and additives such as a binder are unnecessary, it has an advantage in that the amount of material dissolved into acetone is reduced. Further, even if a relatively large amount of cellulose filament fiber is used, fibers are entangled with each other by the high-pressure water jet stream to be an integral body, a high water absorption is obtainable.

While the inventive wiper is composed of a nonwoven fabric obtained by entangling fibers therein with each other by the high-pressure water jet stream, other fiber-entangling means may be used together with the former for obtaining the nonwoven fabric, unless the effect of the present invention is deteriorated.

The present inventors have found that a nonwoven fabric obtained by entangling fibers with each other solely by means other than the high-pressure water jet stream is problematic. For example, in a case wherein fibers are press-bonded by a high-pressure embossing treatment, the fibers are easily separated from each other by friction or re-wetting. When fibers are bonded together by a resinous binder, there is a problem in that the resin is dissolved in acetone. When fibers are bonded together by melting heat-fusible fibers preliminarily mixed with them, a large amount of the heat-fusible fiber must be mixed for the purpose of reducing an amount of micro-matter falling-off from the wiper, which causes a hard hand feeling and is unsuitable for a wiper.

The inventive wiper is not obtainable from a nonwoven fabric resulted from a melt blown method. This is because material used in the melt blown method is limited to heat-fusible synthetic fiber polymer which generates a large amount of material dissolved in acetone, whereby such material is unsuitable for the inventive wiper.

The inventive wiper includes those used in a dry state and a wet state if necessary. Also, the inventive wiper may include those subjected to a sterilization treatment.

According to the inventive wiper, an amount of micro-matter of 100 μm long or more falling-off therefrom is 20,000 pieces/m² or less, preferably 14,000 pieces/m² or less. The amount of micro-matter is preferably as little as possible, most preferably zero. If the amount of micro-matter of 100 μm long or more falling-off therefrom is 20,000 pieces/m² or less, the satisfactory performance is obtainable, of course, in a clean room and also in the cleaning operation of a surface to be coated prior to the coating operation.

According to the inventive wiper, an amount of material dissolved in acetone is 340 mg/kg or less, preferably 190 mg/kg or less. The amount of material dissolved in acetone is preferably as little as possible, most preferably zero. If the amount of material dissolved in acetone is 340 mg/kg or less, acetone having a high dissolving power is usable, and therefore, the persistent contamination of resin or oil within a chamber, which is impossible to be wiped off with water or alcohol, can be cleaned.

The inventive wiper has the water absorption of 8 ml/g or more, preferably 9 ml or more. If the water absorption is 8 ml/g or more, various aqueous solutions such as sulfuric acid or nitric acid can be sufficiently wiped off. While an upper limit of the water absorption is not clearly determined, if it exceeds 20 ml/g, the wiper becomes an aqueous gel which is difficult to maintain its shape as a wiper. Accordingly, the water absorption does not exceed 20 ml/g.

The inventive wiper contains cellulose filament fiber of 40% by weight or more, preferably 85% by weight or more. Further, the cellulose filament fiber is preferably cupra-ammonium rayon fiber. If the cellulose filament fiber is 40% by weight or more, the water absorption becomes 8 ml/g or more, and if the cellulose filament fiber is 85% by weight or more, the water absorption becomes 9 ml/g or more. The content of the cellulose filament fiber is preferably as much as possible, most preferably 100% by weight.

For manufacturing the inventive wiper, a method is proposed, wherein a nonwoven fabric formed by entangling cellulose filament fibers with each other, by a water jet stream under specific conditions, is cut into a plurality of flat sheets.

The high-pressure water jet stream technology used for manufacturing a spun-lace nonwoven fabric is known as a hydro-entangling method. Also, in the method for manufacturing a wet type cellulose spun bonded nonwoven fabric using a cupra-ammonium cellulose stock solution, the high-pressure water jet stream is used as an entangling method.

A total impact energy value (F) of the water jet stream applied to the nonwoven fabric web is represented by a product of an impact power (I) and a water jet energy (E): i.e., I×E which SI unit is J·N/kg. In this regard, I=2 PA′ wherein P is a pressure of a water jet stream [pascal] and A′ is 0.6 A wherein A is a total cross-sectional area of a nozzle [m²]. Also E=PQ/wzv wherein Q is a total amount of water jet stream [m³/sec], w is a fabric weight [kg/m²], z is a width of the nonwoven fabric web [m] and v is a running speed of the nonwoven fabric web [m/sec].

In the inventive method, the total impact energy value (F) is in a range from 0.5×10⁹ to 3.0×10⁹ [joule·newton/kg].

In the usual high-pressure water jet technology, the F value must be 100×10⁹ or more, and in some cases, the entangling treatment is carried out at a high F value of 1800×10⁹ or more. However, it has been found that the wiper obtained from such an excessively entangled nonwoven fabric is liable to generate a large amount of fibrous micro-matter falling-off therefrom. That is, the present inventors have found that if the nonwoven fabric web is obtained under the usual entangling condition, the fibers are complicatedly bent and entangled with each other within the interior of the web to form a number of loops which are broken during the cutting process for manufacturing the wiper and form a source of fibrous micro-matter. Based on such a knowledge, the present invention has been made.

As described above, as the flat sheet-like nonwoven wiper is used by being gripped by the operator's hand while maintaining a sheet shape, a dry breaking strength is preferably 1.5 kgf/5 cm width or more. If the total impact energy value is excessively low in the entangling treatment, the breaking strength of the sheet-like nonwoven wiper is insufficient. Therefore, such a nonwoven fabric must be used as a wiper of a folded shape.

In view of the above-mentioned problem, the inventive method is an epoch-making technique for achieving the dry breaking strength necessary for the sheet-like nonwoven fabric wiper solely by imparting less total impact energy than that thought of in the prior art as well as decreasing the number of micro-loops in the nonwoven fabric.

According to the inventive method, when the entangling treatment is carried out, a buffer plate having an opening degree in a range from 10 to 47% is placed on the nonwoven fabric web supported by a net, and the water jet stream is applied to the nonwoven fabric web from above the buffer plate. That is, by providing the buffer plate, the continuous application of the impact energy to all over the nonwoven fabric web is avoided, and instead, the energy is intermittently applied to necessary portions of the nonwoven fabric web in a spotted manner, whereby it is possible to decrease the number of fiber loops as much as possible and also reduce the amount of fibrous micro-matter falling-off from the web to a large extent, as well as to achieve a sufficient dry breaking strength as the sheet-like nonwoven fabric wiper. Also, as fibers in the web are prevented from entering meshes of the net supporting the nonwoven fabric web by using the buffer plate, there is no breakage of fibers which has often occurred when the nonwoven fabric web is stripped off from the net in the conventional method whereby the generation of fibrous micro-matter is furthermore restricted.

In the present invention, if the opening degree of the buffer plate is less than 10%, a large amount of water jet stream is splashed above the buffer plate to disturb the stable operation, whereby fibers in the nonwoven fabric web are not sufficiently entangled with each other to result in the nonwoven fabric instable in shape. On the other hand, if the opening degree of the buffer plate exceeds 47%, the buffering effect becomes less to form the fibrous loops all over the web surface. The opening degree of the buffer plate is more preferably in a range from 20 to 40%.

A position of the buffer plate may be fixed, or may be adjustable, for example, in the running direction of the nonwoven fabric web or opposite thereto. Also, the buffer plate is located between the water jet nozzle and the nonwoven fabric web. In this regard, a distance between the nonwoven fabric web and the buffer plate is preferably in a range from 5 to 25 mm. A typical buffer plate is a metallic or plastic plain weave net. Alternatively, a perforated plate in which through-holes and shield portions are mixed may be used. The size of the through-hole is preferably 3 mm² or less.

As described above, according to the present invention, an excellent effect is obtainable by skillfully combining the total impact energy value (F) of the water jet stream in the entangling treatment with the buffer plate. The nonwoven fabric treated with the water jet stream is cut as it is or after being combined with other nonwoven fabric into sheet-like pieces to be the inventive sheet-like nonwoven fabric wiper.

According to the present invention, to obtain the sheet-like nonwoven fabric wiper having the water absorption of 8 ml/g or more, the nonwoven fabric preferably contains water-absorbable fibers such as rayon, cotton, jute, pulp, polyvinyl alcohol or polyacrylonitrile fibers.

A nonwoven fabric containing solely non-water absorbable fibers (such as polyester, polyamide or polypropylene fibers) has the water absorption of 3 ml/g or less. While there is a nonwoven fabric wiper imparted with hydrophilic oil for the purpose of improving the water absorption, the water absorption thereof is at most 4.9 ml/g, and on the other hand, the amount of material dissolved into acetone reaches 10,000 mg/kg. Even in a wiper containing polyester fibers of 100% subjected to the hydrophilic treatment, the amount of material dissolved into acetone reaches 1,545 mg/kg. Accordingly, to obtain a high water absorption without increasing the amount of material dissolved into acetone, the cellulose fibers such as rayon fibers (viscose rayon or cupra-ammonium rayon) are preferably mixed.

According to the present invention, as the total impact energy of the water jet stream is small in the entangling treatment, the resultant web is rich in bulkiness in comparison with the conventional product. For example, if the content of the rayon fiber is 40% by weight or more, the water absorption of the resultant wiper is 8 ml/g, and if the content of the rayon fiber is 85% by weight or more, the water absorption of the resultant wiper is 9 ml/g or more. On the other hand, according to the conventional method, when the entangling treatment is carried out by using the water jet stream having a total impact energy value (F) of 1180×10⁹, the water absorption is 6.4 ml/g which is not so high as in the present invention even if the content of rayon fiber is 60% by weight.

The cellulose fiber used is preferably rayon filament fiber such as cupra-ammonium rayon filament fiber for the purpose of reducing the amount of fibrous micro-matter falling-off therefrom. While the water absorption can be facilitated by using cotton fiber as a water absorbable component, a nonwoven fabric of 100% cotton is problematic because oil remaining in natural cotton fibers is dissolved into acetone. The amount of material dissolved into acetone of the marketed nonwoven fabric wiper of 100% cotton is approximately 1,700 mg/kg. Accordingly, it is necessary to restrict the content of cotton, if used, to not increase the amount of material dissolved into acetone. Although pulp fibers may be used as a component of the water absorbable fibers, the fiber length thereof is too short to sufficiently entangle the fibers with each other, whereby the amount of fibrous micro-matter falling-off from the wiper is liable to increase.

### BEST MODES FOR CARRYING OUT THE INVENTION

The present invention will be described in more detail below with reference to the preferred embodiments. Note the present invention should not be limited by these embodiments.

The measurements are as follows:

(1) Amount of Micro-Matter Falling-Off from Wiper

A sample of a wiper was put into clean water of 300 ml in a 1 liter beaker and subjected to the radiation by a supersonic wave for 15 minutes to move dust from the sample into water. After taking out the sample, the water was suckingly filtrated through a black cellulose ester membrane filter of 4.7 cm diameter (manufactured by ADVANTEX Co.; a bore size of 0.8 μm; having a grating), and the number of micro-matter of 100 μm long or more caught on the surface of the filter was counted after image-processing by a color imaging computer (software used; an image processing and analysis software Image Hyper-L provided from INTERQUEST Co.; a binary processing threshold value 110), while being converted to the number of pieces per 1 m² of the sample.

(2) Amount of Material Dissolved into Acetone

A sample of 40 g weight was immersed into acetone of 640 ml at 20° C. for 15 hours to dissolve material in the sample into the acetone to obtain a solution. The solution containing the material was suckingly filtrated through a membrane filter of 1 μm cut (manufactured by ADVANTEX Co. of 47 mm diameter; a PTFE plain surface filter) to remove solid residue, and a volume A (ml) of the filtrated solution was measured.

The solution was condensed in an evaporator to 100 ml or less and, thereafter, vaporized and dried. An amount B (g) of non-volatile residue was measured, from which the amount of material dissolved into acetone was calculated by the following formula:
Amount of material dissolved into acetone (mg/kg)=(B/A)×16×10⁶

(3) Water Absorption

A sample was left in a room conditioned at 20° C. and 65% RH for 15 hours, and then cut into a size of 10 cm square which weight W₁ (g) was measured. The sample was placed on a 10 mesh metallic net formed of a wire of 0.5 mm diameter and immersed in water at 20° C. for 30 seconds together with the net. Thereafter, the sample was horizontally maintained in air on the metallic net for 10 minutes to remove water, and the weight thereof (W₂) was measured again. The water absorption was calculated by the following formula.
Water absorption (ml/g)=(W₂−W₁)/W₁

### EXAMPLES 1 AND 2 AND COMPARATIVE EXAMPLES 1 AND 2

A cellulose filament fiber nonwoven fabric obtained by continuously solidifying and regenerating cupra-ammonium cellulose solution by a wet type method was subjected to the entangling treatment by a water jet stream while variously changing the total impact energy value (F).

The entangling treatment was carried out by placing the nonwoven fabric web on a 40-mesh plain weave net, covering the nonwoven fabric web with a buffer plate formed of a 18-mesh plain weave net having an opening degree of 25%, while fixing the buffer plate at a height of 10 mm above the nonwoven fabric web, and ejecting the water jet stream to the nonwoven fabric web through the buffer plate. The nonwoven fabric web is dried and cut into a square shape of 22.8 cm×22.8 cm to result in a sheet-like nonwoven fabric wiper.

Results are shown in Table 2, from which are seen the following:

In J which is Comparative example 1, fibers were hardly entangled to each other and the dry breaking strength was as weak as 0.3 kgf/5 cm width, which is unsuitable for the wiper.

K and L which are Examples 1 and 2, respectively, had excellent performance suitable for the wiper.

M which is Comparative example 2 was unsatisfactory in the amount of micro-matter falling-off therefrom.

### EXAMPLES 3 TO 5 AND COMPARATIVE EXAMPLE 3

As shown in Table 3, two sheets of a cellulose filament fiber nonwoven fabric obtained by continuously solidifying and regenerating cupra-ammonium cellulose solution by a wet type method were prepared, and a predetermined amount of rayon staple fibers or polyester staple fibers was sandwiched between the two sheets by a method disclosed in Japanese Patent Publication No. 2578503 to result in a composite nonwoven fabric web.

This composite nonwoven fabric web was subjected to the entangling treatment by a water jet stream while variously changing the total impact energy value (F). The entangling treatment was carried out by placing the nonwoven fabric web on a 70-mesh plain weave net, covering the nonwoven fabric web with a buffer plate formed of a 18-mesh plain weave net having an opening degree of 25%, while maintaining the buffer plate at a height of 20 mm above the nonwoven fabric web and moving the buffer plate in the same direction as the moving direction of the nonwoven fabric web at a speed of 1/10 of the web running speed, and ejecting the water jet stream to the nonwoven fabric web through the buffer plate. The nonwoven fabric web is dried and cut into a square shape of 22.8 cm×22.8 cm to result in a sheet-like nonwoven fabric wiper.

Results are shown in Table 3, from which are seen the following:

N which is Comparative example 3 was unsatisfactory in the amount of micro-matter falling-off therefrom and in the water absorption.

P, Q and R which are Examples 3, 4 and 5, respectively, had excellent performance suitable for the wiper.

### EXAMPLES 6 AND 7 AND COMPARATIVE EXAMPLES 4 AND 5

A cellulose filament fiber nonwoven fabric obtained by continuously solidifying and regenerating cupra-ammonium cellulose solution by a wet type method was subjected to the entangling treatment by using various buffer plates shown in Table 4 with a water jet stream having the total impact energy value (F) of 2.7×10⁹ (joule·newton/kg). In this regard, the buffer plate was fixed at a height of 20 mm above the nonwoven fabric web. The nonwoven fabric web was dried and cut into a square shape of 22.8 cm×22.8 cm to result in a sheet-like nonwoven wiper.

Results are shown in Table 4, from which are seen the following:

In S which is Comparative example 4, fibers were hardly entangled with each other to have a weak strength and difficult to maintain its fabric shape, whereby it was unsuitable for a wiper.

T and U which are Example 6 and 7, respectively, had excellent performance suitable for the wiper.

V which is Comparative example 5 is unsatisfactory in the amount of micro-matter falling-off therefrom.

TABLE 1

| | | | Amount of | Amount of | |
|---|---|---|---|---|---|
| | | | micro-matter | material | |
| | | | longer than | extracted into | Water |
| | | | 100 μm | acetone | absorption |
| | Brand | Composition | (pieces/m²) | (mg/kg) | (ml/g) |
| A | TEXWIPE Co. | Pulp 55% | 142,000 | 395 | 5.3 |
| | Technicloth | Polyester 45% | | | |
| B | Lymtech Co. | Pulp 55% | 122,800 | 355 | 5.4 |
| | C1 | Polyester 45% | | | |
| C | Berkshire Co. | Pulp 55% | 105,700 | 243 | 5.4 |
| | DURX 670 | Polyester 45% | | | |
| D | Dupont Co. | Pulp 55% | 140,000 | 133 | 4.6 |
| | Micropure AP | Polyester 45% | | | |
| E | Dupont Co. | Pulp 44% | 125,500 | 206 | 5.6 |
| | Micropure 100 | Polyester 56% | | | |
| F | TEXWIPE Co. | Pulp 55% | 47,200 | 2073 | 4.6 |
| | Technicloth III | Polyester 45% | | | |
| G | Berkshire Co. | Pulp 55% | 29,100 | 2930 | 5.3 |
| | DURX 770 | Polyester 45% | | | |
| H | Dupont Co. | Rayon 40% | 22,500 | 217 | 7.7 |
| | Micropure 10 | Polyester 60% | | | |
| I | Kimbery Co. | Polypropylene | great many | 9880 | 4.9 |
| | Crew | 100% | (impossible to | | |
| | | | measure) | | |

TABLE 2

| | | | | | | Strength at |
|---|---|---|---|---|---|---|
| | | | | | | break in |
| | | | Amount of | Amount of | | dry state |
| | | Total | micro- | material | | (in the |
| | | impact | matter | extracted | | lateral |
| | Fabric | energy | longer than | into | Water | direction) |
| | weight | value (F) | 100 μm | acetone | absorption | (kgf/5 cm |
| Composition | (kg/m²) | (J · N/kg) | (pieces/m²) | (mg/kg) | (ml/g) | width) |

| | | | | | | | | |
|---|---|---|---|---|---|---|---|---|
| J | Comparative | Cellulosic | 0.05 | 0.41 × 10⁹ | — | — | — | 0.3 |
| | example 1 | filament | | | | | | |
| | | fiber | | | | | | |
| | | 100% | | | | | | |
| K | Example 1 | Cellulosic | 0.05 | 0.503 × 10⁹ | 1,227 | 132 | 15 | 1.5 |
| | | filament | | | | | | |
| | | fiber | | | | | | |
| | | 100% | | | | | | |
| L | Example 2 | Cellulosic | 0.05 | 2.95 × 10⁹ | 9,262 | 87 | 11.1 | 2.2 |
| | | filament | | | | | | |
| | | fiber | | | | | | |
| | | 100% | | | | | | |
| M | Comparative | Cellulosic | 0.05 | 87.86 × 10⁹ | 24,300 | 121 | 10.5 | 2.9 |
| | example 2 | filament | | | | | | |
| | | fiber | | | | | | |
| | | 100% | | | | | | |

TABLE 3

| | | | | | | Amount of | |
|---|---|---|---|---|---|---|---|
| | | | | | Amount of | material | |
| | | | | | micro-matter | extracted | |
| | | | Fabric | Total impact | longer than | into | Water |
| | | | weight | energy value | 100 μm | acetone | absorption |
| | | Composition | (kg/m²) | (F) (J · N/kg) | (pieces/m²) | (mg/kg) | (ml/g) |
| N | Comparative | Cellulosic | 0.075 | 7.0 × 10⁹ | 53,400 | 120 | 7.5 |
| | example 3 | filament | | | | | |
| | | fiber 73% | | | | | |
| | | Rayon | | | | | |
| | | staple | | | | | |
| | | fiber 27% | | | | | |
| P | Example 3 | Cellulosic | 0.075 | 2.8 × 10⁹ | 18,390 | 117 | 11.5 |
| | | filament | | | | | |
| | | fiber 73% | | | | | |
| | | Rayon | | | | | |
| | | staple | | | | | |
| | | fiber 27% | | | | | |
| Q | Example 4 | Cellulosic | 0.075 | 2.7 × 10⁹ | 14,130 | 205 | 8.3 |
| | | filament | | | | | |
| | | fiber 73% | | | | | |
| | | Polyester | | | | | |
| | | staple | | | | | |
| | | fiber 27% | | | | | |
| R | Example 5 | Cellulosic | 0.075 | 0.60 × 10⁹ | 6,200 | 315 | 8 |
| | | filament | | | | | |
| | | fiber 40% | | | | | |
| | | Polyester | | | | | |
| | | staple | | | | | |
| | | fiber 60% | | | | | |

TABLE 4

| | | | | Total | | | Amount of | Amount of | |
|---|---|---|---|---|---|---|---|---|---|
| | | | | impact | | | micro- | material | |
| | | | | energy | | | matter | extracted | |
| | | | Fabric | value | | Opening | longer than | into | Water |
| | | | weight | (F) | Buffer | degree | 100 μm | acetone | absorption |
| | | Composition | (kg/m²) | (J · N/kg) | plate | (%) | (pieces/m²) | (mg/kg) | (ml/g) |
| S | Comparative | Cellulosic | 0.05 | 2.7 × 10⁹ | 30 | 8 | — | — | — |
| | example 4 | filament | | | mesh | | | | |
| | | fiber 100% | | | double | | | | |
| | | | | | twill | | | | |
| | | | | | weave | | | | |
| T | Example 6 | Cellulosic | 0.05 | 2.7 × 10⁹ | 25 | 32 | 5,590 | 105 | 12.5 |
| | | filament | | | mesh | | | | |
| | | fiber 100% | | | plain | | | | |
| | | | | | weave | | | | |
| U | Example 7 | Cellulosic | 0.05 | 2.7 × 10⁹ | 8 mesh | 46.2 | 8,600 | 120 | 11 |
| | | filament | | | plain | | | | |
| | | fiber 100% | | | weave | | | | |
| V | Comparative | Cellulosic | 0.05 | 2.7 × 10⁹ | none | 100 | 26,900 | 92 | 9.5 |
| | example 5 | filament | | | | | | | |
| | | fiber 100% | | | | | | | |

### CAPABILITY OF EXPLOITATION IN INDUSTRY

As the inventive sheet-like nonwoven fabric wiper is low in the amount of micro-matter falling-off therefrom and material dissolved into acetone as well as more in water absorption, it is extremely suitable for an industrial wiper used in a clean room or for a surface cleaning prior to the coating operation. Also, as acetone having a high dissolving power can be used, it is possible to completely clean persistent contamination of resin or oil in a chamber as well as to sufficiently wipe up various aqueous solutions such as sulfuric acid or nitric acid.

1. A sheet-like wiper of a nonwoven fabric formed by entangling fibers with each other by a high-pressure water jet stream, wherein an amount of micro-matter of 100 μm long or more falling-off therefrom is 20,000 pieces/m² or less, an amount of material dissolved therefrom into acetone is 340 mg/kg or less, and the water absorption is 8 ml/g or more.

2. A wiper as defined by claim 1, wherein the amount of micro-matter of 100 μm long or more falling-off therefrom is 14,000 pieces/m² or less, the amount of material dissolved therefrom into acetone is 190 mg/kg or less, and the water absorption is 9 ml/g or more.

3. A wiper as defined by claim 1 or 2, wherein the nonwoven fabric contains cellulose filament fiber of 40% by weight or more, and the cellulose filament fiber is cupra ammonium rayon.

4. A wiper as defined by claim 3, wherein the content of the cellulose filament fiber is 85% by weight or more.

5. A method for manufacturing a wiper, comprising a process for producing nonwoven fabric of cellulose filament fiber by a wet type cellulose spun-bonding method wherein cupra-ammonium cellulose solution is continuously coagulated, regenerated, rinsed, entangled, dried and taken up to form a nonwoven fabric, a process for combining the nonwoven fabric with other nonwoven fabric if necessary, a process for cutting the nonwoven fabric to be a flat sheet-like wiper, a process for wetting the wiper with liquid if necessary and/or a process for sterilizing the wiper if necessary, wherein the entanglement process is carried out by placing a buffer plate having an opening degree in a range from 10 to 47% on a non-entangled web and applying onto the buffer plate a water jet stream having a total impact energy value (F) in a range from 0.5×10⁹ to 3.0×10⁹ joule·newton/kg to entangle fibers in the web.
